(19) United States
(12) Patent Application Publication
(10) Pub. No.: US 2021/0236980 A1
(43) Pub. Date: Aug. 5, 2021

(54) PHOTO-CATALYTIC OXIDATION DEVICE FOR ORGANIC WASTE GAS

(71) Applicant: GAOYOU GAOHE PHOTOELECTRICITY EQUIPMENT CO., LTD., Gaoyou, Jiangsu (CN)

(72) Inventor: Shenghe ZHU, Gaoyou, Jiangsu (CN)

(73) Assignee: GAOYOU GAOHE PHOTOELECTRICITY EQUIPMENT CO., LTD., Gaoyou, Jiangsu (CN)

(21) Appl. No.: 17/256,176

(22) PCT Filed: Jul. 10, 2019
(86) PCT No.: PCT/CN2019/095503

§ 371 Date: Dec. 25, 2020

(30) Foreign Application Priority Data
Oct. 26, 2018 (CN) 201811255462.2

(51) Int. Cl. B01D 53/00; B01D 53/86; B01D 53/88

(52) U.S. Cl. CPC B01D 53/007; B01D 53/8687; B01D 2259/806; B01D 2257/708; B01D 2259/804; B01D 53/88

(57) ABSTRACT

An organic waste gas photocatalytic oxidation device is provided, which includes a shell with an air inlet and an air outlet, and a microwave generator for forming a microwave electromagnetic field in the shell; the air inlet and the air outlet of the shell are both provided with a catalyst mesh plate, and the shell is provided with an ultraviolet lamp tube and a photocatalyst plate. By combining three technologies of microwave, ultraviolet and photocatalyst.

### FIELD

The present invention relates to the technical field of organic waste gas treatment equipment, in particular to an organic waste gas photocatalytic oxidation device.

### BACKGROUND

At present, ultraviolet photocatalytic oxidation technology is widely used in the treatment of organic waste gas. Specifically, it is directly connected to the waste gas collection device. Under the ultraviolet irradiation, benzene, toluene, xylene, non methane total hydrocarbon, TVOC and other substances that are difficult to degrade in the organic waste gas are removed through contact reaction. However, the current processing device is mainly the microwave module of microwave driven ultraviolet lamp, which is mainly composed of a closed microwave electromagnetic field cavity through metal materials. The cavity is equipped with ultraviolet lamp, and the microwave field energy is radiated to the cavity through the microwave device for photocatalytic action. This kind of microwave module has low efficiency and short service life in the treatment of VOCs.

### SUMMARY

In order to solve the above technical problems, the invention proposes an organic waste gas photocatalytic oxidation device, which can efficiently catalyze the oxidation of VOCs molecules by treating organic waste gas through microwave, ultraviolet and photocatalyst composite technology.

To achieve the above purpose, the technical scheme of the invention is as follows.

An organic waste gas photocatalytic oxidation device includes a shell with an air inlet and an air outlet, and a microwave generator for forming a microwave electromagnetic field in the shell; the air inlet and the air outlet of the shell are both provided with a catalyst mesh plate, and the shell is provided with an ultraviolet lamp tube and a photocatalyst plate.

The microwave generator includes a microwave power supply and a microwave head, the microwave power supply is electrically connected with the microwave head, and the microwave head is fixed on the shell.

Preferably, the input power of the microwave head is 1200 w-1500 w.

The air inlet and the air outlet are relatively arranged, and the catalyst mesh plate is a metal honeycomb mesh plate coated with nano-TiO2 on the surface.

Preferably, the photocatalyst plate is parallel to and adjacent to the ultraviolet lamp tube.

More preferably, when the ultraviolet lamp tube and the photocatalyst plate are provided with a plurality of groups, the ultraviolet lamp tube and the photocatalyst plate are arranged at intervals.

In one embodiment, the shell is cuboid, and the air inlet and outlet are arranged on the opposite end face or side of the shell.

Preferably, the width value and the height value of the shell are equal, and the length value of the shell is the square of the width value.

More preferably, the size of the shell is 900 mm×300 mm×300 mm or 1600 mm×400 mm×400 mm.

More preferably, the size of the shell is 900 mm×300 mm×300 mm or 1600 mm×400 mm×400 mm.

Compared with the prior art, the invention has the following effects:

By combining microwave, ultraviolet and photocatalyst technologies, the invention can efficiently catalyze the oxidation of VOCs molecules, the hydroxyl photocatalytic oxidation effect generated by ultraviolet irradiation of photocatalyst is higher than that of traditional ultraviolet photolysis, the VOCs treatment efficiency is increased by more than two times, and the effective life is prolonged by five times; 2. The invention is provided with catalyst nets at both the air inlet and the air outlet 3. A movable door is arranged on the shell to facilitate the maintenance and replacement of the ultraviolet lamp tube and photocatalyst plate in the shell.

### BRIEF DESCRIPTION OF THE DRAWINGS

In order to explain the technical scheme in the embodiment of the invention more clearly, the drawings needed in the description of the embodiment will be briefly introduced below.

FIG. 1 is a stereogram of an organic waste gas photocatalytic oxidation device in the embodiment of the invention;

FIG. 2 is the right view of FIG. 1;

FIG. 3 is a sectional view at A-A in FIG. 2;

FIG. 4 is a stereoscopic view of the organic waste gas photocatalytic oxidation device in another embodiment of the present invention;

FIG. 5 is the main view of FIG. 4;

FIG. 6 is the sectional view of B-B in FIG. 5.

### DETAILED DESCRIPTION

The invention will be further described in detail in combination with the attached drawings. It should be noted that the organic waste gas photocatalytic oxidation device in the embodiment can be installed vertically or horizontally when in use.

An organic waste gas photocatalytic oxidation device includes a shell 1 with an air inlet 101 and an air outlet 102, and a microwave generator for forming a microwave electromagnetic field in the shell 1; a catalyst mesh plate 2 is arranged on the air inlet 101 and air outlet 102 of the shell 1, and the ultraviolet light tube 3 and the photocatalyst plate 4 are arranged in the shell 1.

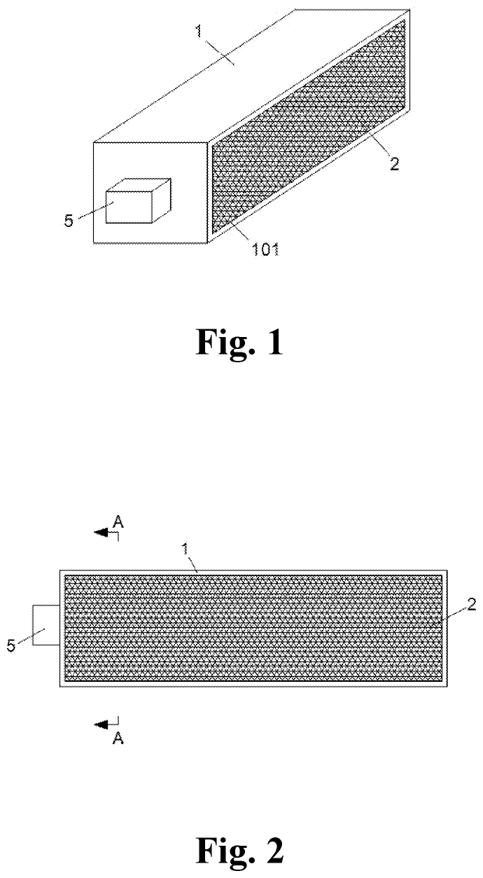

In a specific embodiment, as shown in FIGS. 1-3, the shell 1 is cuboid, the size of the shell 1 is 900 mm×300 mm×300 mm, and the shell 1 is made of 304 stainless steel. The air inlet 101 and air outlet 102 are arranged on the side wall of the shell 1, and the air inlet 101 and the air outlet 102 are arranged relatively. The catalyst mesh plate 2 is arranged on the air inlet 101 and the air outlet 102. The catalyst mesh plate 2 is an aluminum alloy honeycomb mesh plate coated with nano-TiO2.

The microwave generator comprises a microwave power supply (not shown in the figure) and a microwave head 5, the microwave power supply is electrically connected with the microwave head 5, the microwave head 5 is fixed on the end wall of the shell 1, and the input power of the microwave head 5 is 1200 W.

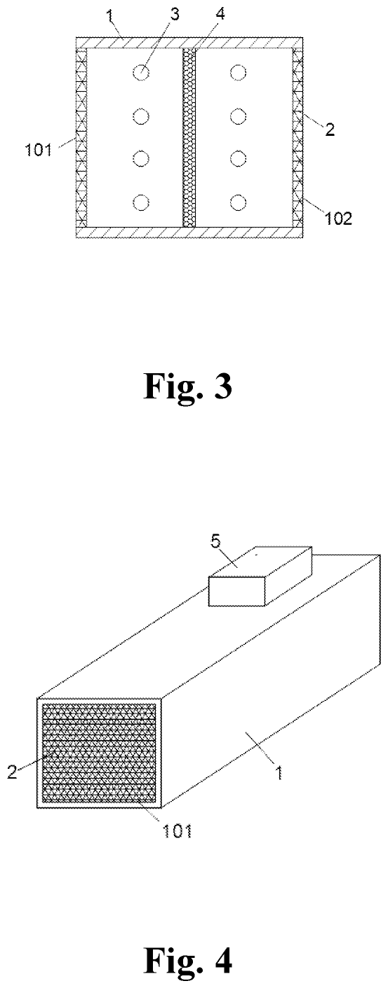

As shown in FIG. 3, the ultraviolet lamp tube 3 is provided with two groups, each group of ultraviolet lamp tube 3 is parallel to the air inlet 101 and air outlet 102, the photocatalyst plate 4 is arranged between the two groups of ultraviolet lamp tubes 3 and is parallel to the photocatalyst plate 4, the photocatalyst plate 4 is arranged close to the ultraviolet lamp tube 3, and the photocatalyst plate 4 is a ceramic photocatalyst net plate coated with nano-TiO2 on the surface. For the number of ultraviolet lamp tube 3 and photocatalyst plate 4, the invention does not make specific requirements, and can be added or decreased according to the specific situation.

When the organic waste gas enters the shell 1 through the air inlet 101, it is first broken by the microwave ultra-high frequency electromagnetic field and cuts the molecular bond to form smaller molecules, which is conducive to the photocatalytic oxidation of ultraviolet rays. The specific mechanism is that the ultraviolet light emitted by the ultraviolet lamp 3 irradiates the TiO2 on the photocatalyst plate 4 to produce —O and —Oh oxidation groups, thus strengthening the photocatalytic oxidation of ultraviolet rays, gradually reducing VOCs molecules, and finally forming harmless water and CO2. The treatment efficiency of VOCs is increased by more than two times, and the effective life of the device is prolonged by five times.

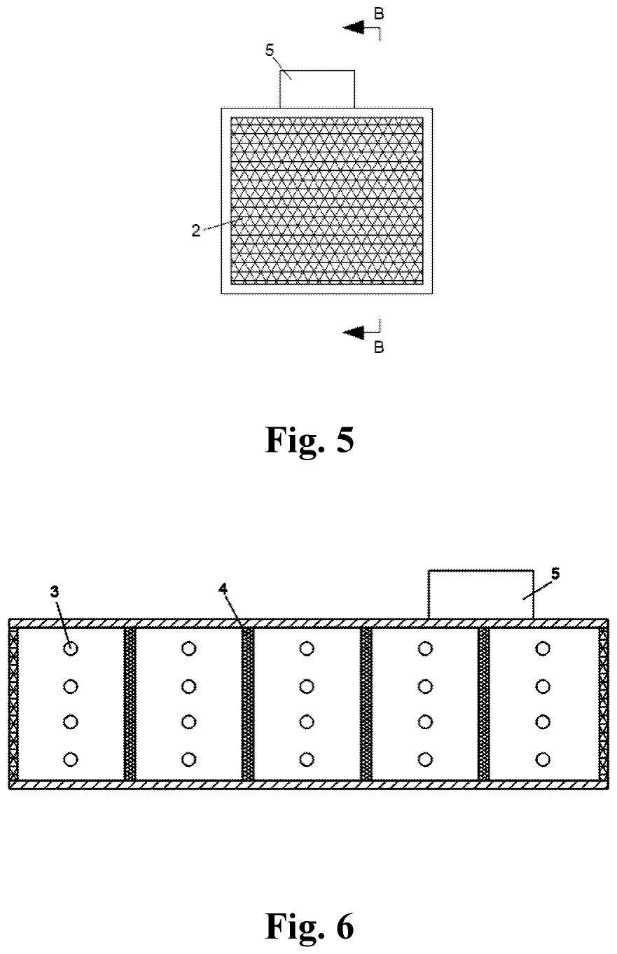

In another specific embodiment, as shown in FIGS. 4-6, the size of the shell 1 is 1600 mm×400 mm×400 mm, and the air inlet 101 and air outlet 102 are arranged on the end wall of the shell 1. At this time, the microwave head 5 is set on the top wall of the shell 1, and the input power of the microwave head 5 is 1500 W. As shown in FIG. 6, the shell 1 is provided with four groups of photocatalyst plates 4 and five groups of ultraviolet lamp tubes 3, and the photocatalyst plates 4 and the ultraviolet lamp tubes 3 are arranged at intervals.

In addition, in order to facilitate the replacement and maintenance of the ultraviolet lamp tube 3 and the photocatalyst plate 4 in the shell 1, the shell 1 is provided with a movable door, which can be the whole side wall or end wall of the shell 1, or a through groove with a cover plate on the side wall or end wall. During maintenance, the ultraviolet lamp tube 3 and the photocatalyst plate 4 can be replaced or maintained by opening the movable door.

It should be pointed out that for ordinary technicians in the art, on the premise of not departing from the inventive concept of the invention, a number of modifications and improvements can be made, which belong to the protection scope of the invention.

What is claimed is:

1. A photocatalytic oxidation device for organic waste gas, comprising: a shell (1) with an air inlet (101) and an air outlet (102) and a microwave generator for forming a microwave electromagnetic field in the shell (1);
the air inlet (101) and the air outlet (102) of the shell (1) are provided with a catalyst mesh plate (2), and the shell (1) is provided with an ultraviolet lamp tube (3) and a photocatalyst plate (4).

2. The photocatalytic oxidation device for organic waste gas according to claim 1, wherein,
the microwave generator comprises a microwave power supply and a microwave head (5), the microwave power supply is electrically connected with the microwave head (5), and the microwave head (5) is fixed on the shell (1).

3. The photocatalytic oxidation device for organic waste gas according to claim 2, wherein,
the input power of the microwave head (5) is 1200 w-1500 w.

4. The photocatalytic oxidation device for organic waste gas according to claim 1, wherein,
the air inlet (101) and the gas outlet (102) are arranged relatively, and the catalyst mesh plate (2) is a metal honeycomb mesh plate coated with nano-TiO2.

5. The photocatalytic oxidation device for organic waste gas according to claim 1, wherein,
the photocatalyst plate (4) is parallel and adjacent to the ultraviolet lamp tube (3).

6. The photocatalytic oxidation device for organic waste gas according to claim 5, wherein,
when the ultraviolet lamp tube (3) and the photocatalyst plate (4) are provided with multiple groups, the ultraviolet lamp tube (3) and the photocatalyst plate (4) are arranged at intervals.

7. The photocatalytic oxidation device for organic waste gas according to claim 1, wherein,
the shell (1) is a cuboid, and the air inlet (101) and air outlet (102) are arranged on the opposite end face or side of the shell (1).

8. The photocatalytic oxidation device for organic waste gas according to claim 7, wherein,
the width value and height value of the shell (1) are equal, and the length value of the shell (1) is the square of the width value.

9. The photocatalytic oxidation device for organic waste gas according to claim 8, wherein,
the size of the shell (1) is 900 mm×300 mm×300 mm or 1600 mm×400 mm×400 mm.

10. The photocatalytic oxidation device for organic waste gas according to claim 1, wherein,
the shell (1) is provided with a movable door for replacing and repairing the photocatalyst plate (4) and the ultraviolet lamp tube (3).
